(19) United States
(12) Patent Application Publication
(10) Pub. No.: US 2016/0200288 A1
(43) Pub. Date: Jul. 14, 2016

(54) AN IMPROVED SUPPLEMENTAL RESTRAINT SYSTEM WITH SIX RESTRAINT POINTS

(71) Applicants: Minsun KIM, Astoria, NY (US); Buseon KIM, Abingdon, MD (US)

(72) Inventor: Taesoo KIM, Seoul (KR)

(21) Appl. No.: 14/916,572

(22) PCT Filed: Sep. 19, 2013
(86) PCT No.: PCT/IB2013/002246

§ 371 Date: Mar. 4, 2016

Related U.S. Application Data
(63) Continuation of application No. 14/025,787, filed on Sep. 12, 2013, now abandoned.

(51) Int. Cl. B60R 22/14; B60R 22/10

(52) U.S. Cl. CPC B60R 22/14; B60R 22/105

(57) ABSTRACT

A supplemental restraint system (100) that can be worn by a passenger and that can be attached to a conventional seat belt having at least a shoulder belt section and a lap belt section. The supplemental restraint system (100) primarily includes a body component (120) and a strap component (140). The body component (120) is provided with two first belt holders (126) on its front body member (122), each of which is positioned near the shoulder portion of the body component (120). Two second belt holders (128) are provided on an end portion (122a) of the front body member (122) extending to the lap area of the passenger. The first and second belt holders (126, 128) are configured to securely hold in place the shoulder and lap belt 120 sections, respectively, of the conventional seat belt. The strap component (140) includes a first strap member (142) and a second strap member (144), the latter being configured to receive a seated passenger's hips in such a manner that the passenger's body is prevented from sliding out of the supplemental restraint system (100).

### TECHNICAL FIELD

The present invention generally relates to safety equipment that can be attached to a conventional seat belt and, more particularly, to a supplemental restraint system with six restraint points and having a body component attachable to shoulder and lap belt sections of said conventional seat belt.

### BACKGROUND

Car crashes remain one of the leading causes of death for children. When driving with these young people on board, it is often safe to restrain their bodies in the seats of vehicles so as to protect them from potential injuries that may be caused by a road accident. Although cars are generally equipped with seat belts providing considerable safety for passengers, the level of protection offered by these conventional seat belts may not be sufficient for children whose body sizes are generally smaller as compared with adults. Often, these seat belts come in a standard size and are installed in accordance with manufacturers' customary instructions. With the size of such conventional seat belts, there is no way to restrain children tightly and within narrow limits. Even the use of forward facing and rear facing booster seats have become inefficient and economically impractical, as children who have outgrown such booster seats can no longer use them.

U.S. Pat. No. 4,226,474 issued to Dorothy Rupert on Oct. 7, 1980 discloses a safety vest which includes a pair of shoulder straps interconnected by a pair of waist straps, a closure device at the back of the safety vest and fastener receiving elements on the shoulder straps and one of the waist straps to which may be attached fastening devices associated with the seat for releasably fastening a person wearing the safety vest to a seat.

U.S. Pat. No. 5,733,014 issued to E-Z-On Products, Inc. on Mar. 31, 1998 discloses another safety vest mainly having a harness that has a pair of lateral torso straps adapted to be placed around the torso of the passenger, a pair of shoulder straps extending over the shoulders and intersecting with the torso straps, and a seat strap portion that fastens to a seat back and fastens to the harness, wherein an existing vehicle seat belt also fastens to the torso straps to secure the passenger to the seat.

U.S. Pat. No. 6,820,902 issued to Hyun Kim on Nov. 23, 2004 discloses another safety vest utilizing a five-point restraint system formed by combining a conventional vehicle restraint system having a lap belt section and a shoulder belt section (along which the first three restraint points lie) and a supplemental restraint system having two vertically oriented belts (along which the fourth restraint point lies) and one horizontally oriented belt (along which the fifth restraint point lies), wherein the lap and shoulder belt sections of the conventional vehicle restraint system are attached within a clip on the vertical and horizontal belts of the supplemental restraint system. The system further provides that the belts are completely adjustable to the height and girth of any user.

Although the above disclosed safety vests and supplemental restraint system allow for a secured manner of holding a child in place, the overall safety of the child using the same system is not guaranteed, as the safety vest in which harness is provided could be released accidentally, for example, where the vest is loosely worn, by sudden descending or sliding movements of children most especially during times that they wish to play. The case is also the same when a child desires to reach a distant object and consequently keeps pressing in the direction of an opening formed either by the horizontally oriented belt as disclosed in U.S. Pat. No. 6,820,902, by the hip strap as disclosed in U.S. Pat. No. 5,733,014, and by the lower waist strap as disclosed in U.S. Pat. No. 4,226,474, ultimately resulting in an inadvertent release of the entire safety vest or supplemental restraint system out of the child's body.

### SUMMARY OF THE INVENTION

A primary object of the present invention is to provide an improved supplemental restraint system for use in restraining a child in a seat of a vehicle equipped with safety harness having a shoulder belt section and a lap belt section in which retention of a body when inserted into the supplemental restraint system is guaranteed thereby preventing the body from sliding out of the supplemental restraint system.

The present invention provides a supplementary restraint system comprising (a) a body component having a front body member and a back body member defining a neck opening for receiving a wearer's neck and head, the front body member having one end portion that extends to a wearer's lap, the body component further having at least one first belt holder disposed on the front body member thereof for receiving a shoulder belt section of a safety harness, the body component further having at least one second belt holder disposed on the end portion of the front body member for receiving a lap belt section of a safety harness, wherein the first belt holder is adapted to serve as a chest restraint system and the second belt holder is adapted to serve as a lap restraint system, and (b) a strap component having a first strap member and a second strap member, the first strap member being disposed on the body component for receiving a wearer's body, the second strap member extending from the body component for receiving a wearer's hips.

The provision of the second strap member extending from the body component for receiving a wearer's hips ensures that the wearer's body is prevented from sliding out of the body component at all times when the supplemental restraint system is in use. In one embodiment, a suspender is provided in the strap component, and the suspender is in the form of a continuous loop with detachable connection point. The suspender is arranged to suspend a portion of the second strap member that lies along the concourse of a wearer's hips from the lower end portion of the front body member. In this manner, the second strap member is prevented from possible displacement in the direction away from the wearer's hips.

Preferably, the front body member includes two first belt holders that form part of the chest restraint system. Each of the two first belt holders includes a side-release fastening arrangement. Thus, the shoulder belt section of a conventional seat belt can be inserted easily into one of the two first belt holders. The side-release fastening arrangement also allows easy removal of the shoulder belt section of a conventional seat belt from any of the two first belt holders by virtue that said side-release fastening arrangement is made of plastic material. Preferably, the front body member also includes two second belt holders that form part of the lap restraint system. Each of the two second belt holders includes a side-release fastening arrangement. The lap belt section of a conventional seat belt can be inserted easily into the two second belt holders. The side-release fastening arrangements also allow easy removal of the lap belt section of a conventional seat belt from the two second belt holders by virtue that said side-release fastening arrangements are likewise made of plastic materials. Unlike metallic materials which are vulnerable to deformation during a vehicle collision which in turn may cause non-release of the first and second belt holders, durable plastic materials when broken due to an excessive impact during such a vehicle collision can easily be disassembled from any material to which they are attached. Once any of the plastic side-release fastening arrangements is broken, the first and second belt holders can be readily released individually and therefore the supplemental restraint system worn by its wearer can be detached immediately from the vehicle's safety harness.

Preferably, the first strap member of the front body member is adjustable and is provided with another side-release fastening arrangement. Thus, the body component can be secured tightly around the waist portion of the wearer of the supplemental restraint system. More preferably, the first strap member can be tightened or otherwise loosened in a bilateral direction around the wearer's waist portion in order for the first strap member to better fit the wearer's waist portion.

Preferably, the back body member includes two lengths of support straps, each of which has a substantially narrow width. Each of these support straps has two ends, one of which is attached to the piece of material extending from the unitary length of the front and back body members while the other is a free end that is arranged to pass through a channel formed in the first strap member. More preferably, the support straps are made of flexible materials to fit the contour or curves of the wearer's body and have lengths that are adjustable to suit the length of the wearer's torso. The lengths of the support straps are configured to be adjustable without using any hardware component.

For better understanding of the invention and to show how the same may be performed, a preferred embodiment thereof will now be described, by way of non-limiting examples only, with reference to the accompanying drawings.

### BRIEF DESCRIPTION OF DRAWINGS

FIG. 1 is an isometric view of a preferred embodiment of a supplemental restraint system according to the invention;

FIG. 1a is a fragmentary view of FIG. 1, enlarged to show a preferred embodiment for a first belt holder of the supplemental restraint system as shown in FIG. 1;

FIG. 1b is another fragmentary view of FIG. 1, enlarged to show an alternative embodiment for a first belt holder of the supplemental restraint system as shown in FIG. 1;

FIG. 2 is view showing in great detail a preferred embodiment for a back body member of the supplemental restraint system as shown in FIG. 1;

FIG. 2a is a cross sectional fragmentary view of FIG. 2, enlarged to shown an embodiment for a back body member of the supplemental restraint system as shown in FIG. 1;

FIG. 3 is an isometric view of a preferred embodiment for a second strap member of the supplemental restraint system as shown in FIG. 1;

FIG. 3a is a fragmentary view of FIG. 3, enlarged to show a preferred embodiment for a suspender of the supplemental restraint system as shown in FIG. 3; and

FIG. 4 is a front view of an embodiment for a supplemental restraint system of the invention in use.

### DESCRIPTION OF PREFERRED EMBODIMENT

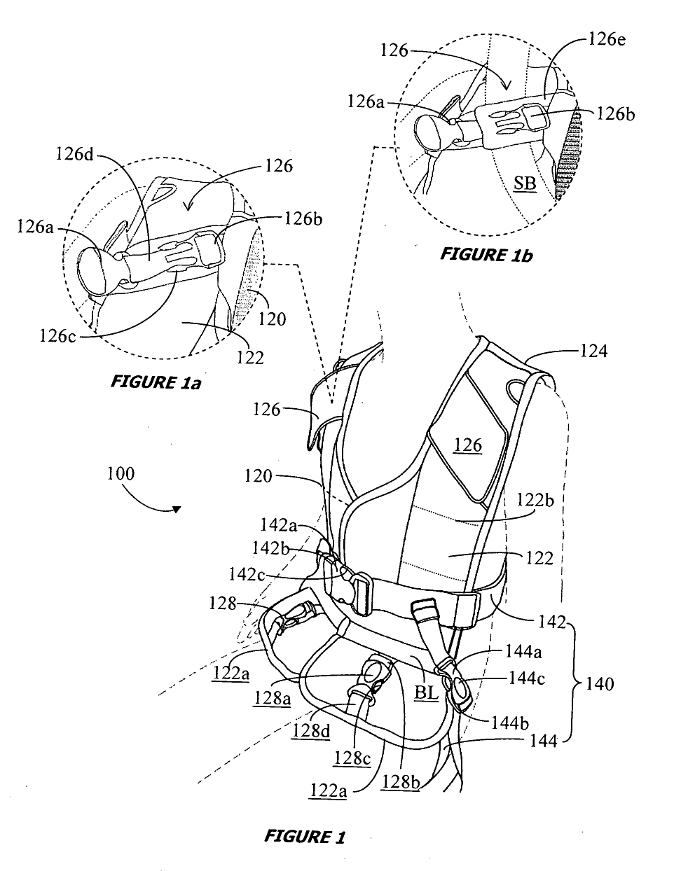

Referring to FIG. 1, the supplemental restraint system of the preferred embodiment is generally designated by reference numeral 100, and it primarily includes a body component 120 and a strap component 140. More particularly, an isometric view of the supplemental restraint system 100 of the present invention is shown in FIG. 1, and the supplemental restraint system 100 is generally arranged to restrain a passenger in a seat of a vehicle that is conventionally equipped with a safety harness or more commonly known as “seat belt”. It is known in the art that such a conventional seat belt is formed of a loop used in such a way that a section of it serves as a shoulder belt and another section of it as a lap belt. A shoulder belt is the section of the loop that, in use, passes over the torso area of a passenger while a lap belt is the section of the loop that, in use, passes over the lap area of a passenger in a seated position inside a vehicle. These shoulder and lap belt sections of the conventional seat belt, in use, inherently provide a three-point restraint system. In order to restrain a passenger in a seated position, the body component 120 and the strap component 140 are worn by the passenger and the body component 120 is attached to the shoulder belt section and as well as to the lap belt section of the loop formed by the conventional seat belt. Two more restraint points are available on the body component 120. This means that the attachment of the body component 120 to the shoulder and lap belt sections of the conventional seat belt all in all provides a five-point restraint system which at present is required by the Federal Motor Vehicle Safety Standards and Regulations of the United States Department of Transportation. With more particularity, a seat belt assembly as stipulated in said standard must include pelvic and upper torso restraints.

The illustrated body component 120 mainly comprises a front body member 122 and a back body member 124. A neck opening is formed by the front body member 122 and the back body member 124, and this opening is of sufficient size in order to receive the neck and head of any passenger wearing the supplemental restraint system 100. When worn by a passenger, one end portion 122a of the front body member 122 extends to the lap area of the passenger, practically near the front portion of the passenger's hips. The end portion 122a of the front body member 122 is adapted to fold when a wearer of the supplemental restraint system 100 is in a seated position. Furthermore, the end portion 122a of the body component 120 and the front body member 122 are one-piece and are separated by at least one layer of strap sewn along a border line (BL) between the end portion 122a of the body component 120 and the front body member 122. A first belt holder 126, adapted to serve as a chest restraint system, is provided on the front body member 122 of the body component 120, preferably near the shoulder portion of the body component 120. In one embodiment, there are two first belt holders 126 forming part of the chest restraint system that are disposed on the surface near the shoulder portions of the body component 120 so that a shoulder belt section of a conventional seat belt may be attached in either of the two first belt holders 126, depending upon the location where a passenger is seated. Preferably, each of the first belt holders 126 is in the form of quick-release or side-release fastening arrangement which, as known in the art, typically comprises a first female buckle member 126a and a first male buckle member 126b. The first male buckle member 126b is typically provided with a first locking bar 126c adapted to be received in an open chamber of the first female buckle member 126a. The side-release fastening arrangement is connected to a first auxiliary band 126d fixedly attached to each of the shoulder portions of the body component 120. A second belt holder 128, adapted to serve as a lap restraint system, is further provided on the front body member 122 of the body component 120, preferably near the end portion 122a of the front body member 122. In one embodiment, there are two second belt holders 128 that are disposed on the surface of the end portion 122a of the front body member 122. Preferably, the two second belt holders 128 are likewise in the form of side-release fastening arrangement, each of which having a second female buckle member 128a and a second male buckle member 128b. The second male buckle member 128b is likewise provided with a second locking bar 128c to be received in an open chamber of the second female buckle member 128a. The side-release fastening arrangement is connected to a second auxiliary band 128d fixedly attached to the end portion 122a of the front body member 122 of the body component 120.

The illustrated strap component 140 includes a first strap member 142 and a second strap member 144. The first strap member 142 is adaptively connected with the body component 120 so as to fit about and around an upper waist region, below the lower torso region, of a passenger wearing the supplemental restraint system 100. Together with the body component 120, the first strap member 142 of the strap component 140 defining a circumference characterized by a first end portion and a second end portion substantially opposite the first end portion receives a passenger's body. Preferably, the first and second end portions of the circumference defined by the first strap member 142 is attached to the front body member 122 of the body component 120. Fixedly attached to both the first end portion and the second end portion of the first strap member 142 is a third side-release fastening arrangement comprising a third female buckle member 142a and a third male buckle member 142b. The third male buckle member 142b is provided with a third locking bar 142c adapted to be received in an open chamber of the third female buckle member 142a. In another preferred embodiment, the first strap member 142 can be tightened or otherwise loosened in a bilateral direction around the wearer's waist portion in order for the first strap member 142 to fit the wearer's waist portion. The first strap member 142 includes at least two separate portions which enable bilateral adjustment. The second strap member 144, on the other hand, is configured to extend from the body component 120. Preferably, the second strap member 144 includes a fourth side-release fastening arrangement attached to both end portions thereof. Similar to the third side-release fastening arrangement of the first strap member 142, the fourth side-release fastening arrangement is provided with fourth female and male buckle members 144a, 144b that can be attached together when a fourth locking bar 144c of the fourth male buckle member 144b is received in an open chamber of the fourth female buckle member 144a. As an alternative to the fourth side-release fastening arrangement, suitable fastening devices may also be used such as a snap fastener or commonly known in the industry as snap button fastener. A fastener of this type has a pair of interlockable discs that can be used to fasten at least two layers of materials. In effect, the second strap member 144 provides another restraint point on the hip portion of a seated passenger. This restraint point is in addition to the required five restraint points provided by the attachment of the body component 120 and shoulder and lap belt sections of a conventional seat belt. It is therefore apparent from herein disclosure that the supplemental restraint system 100 of the present invention, when attached to shoulder and lap belt sections of a conventional seat belt, provides a six-point restraint system. It is an improvement of the required five-point restraint system and a solution to the unintentional release of the supplemental restraint system 100 out of the passenger's body. The six-point restraint system of the present invention also prevents a wearer's head from coming in contact with the body component 120 specially in cases where the wearer is sleeping and hence unconscious.

Although in most instances the side-release fastening arrangements effectively serve their intended purpose to allow easy insertion and removal of shoulder belt and lap belt sections of a loop formed by a conventional seat belt that is commonly pre-installed in a vehicle, other means for attaching the supplemental restraint system 100 to such shoulder and lap belt sections may alternatively be employed, depending upon a specific purpose. For example, velcro arrangement may also be used. Using such a velcro arrangement, a passenger or user of the supplemental restraint system 100 is offered with great convenience to just lift one portion of the velcro arrangement in order to allow insertion or removal of the shoulder and lap belt sections from their attachment to the supplemental restraint system 100. The side-release fastening arrangements allow easy removal of the shoulder belt section and lap belt section of a conventional seat belt from any of the two first belt holders 126 and from the two second belt holders, respectively, by virtue that said side-release fastening arrangements are made of plastic material. Unlike metallic materials which are vulnerable to deformation during a vehicle collision which in turn may cause non-release of the first and second belt holders 126, 128, durable plastic materials when broken due to an excessive impact during such a vehicle collision can easily be disassembled from any material to which they are attached. Once any of the plastic side-release fastening arrangements is broken, the first and second belt holders 126, 128 can be readily released individually and therefore the supplemental restraint system worn by its wearer can be detached immediately from the vehicle's safety harness or seat belt.

Still referring to FIG. 1, according to one embodiment of the present invention, the front body member 122 is characterized by a unitary length of pliable material, such as textiles of natural and/or synthetic fibers, elastomeric materials suitable for garment construction, and/or natural or synthetic leather materials, and/or a combination of any of the foregoing. Plural layers of any of the aforementioned materials or any suitable combinations thereof may also be provided. In one embodiment, the material of the front body member 122 may likewise be provided with cushion or padding. For example, the front body member 122 can be provided with a 3-millimeter cushion or padding in the form of a foam. The cushion or padding absorbs any impact that may be imparted to a passenger during a vehicle collision and hence provides the passenger with sufficient protection against possible impact-related injuries. A 7-millimeter open cell foam can also be added over the 3-millimeter cushion in areas that require high degree of protection. A person skilled in the art can easily realize various modifications that can be made to the front body member 122 of the supplemental restraint system 100 of the present invention. One such advantageous modification is providing a series of sectional elements 122b that can be formed across an outer surface of the front body member 122. Any number of suitable sectional elements 122b may be disposed on the surface of the front body member 122 to achieve a desired flexibility of the front body member 122. The sectional elements 122b can be formed by sewing an outer surface of the front body member 122. The sectional elements 122b can also be sewn with the padding attached to the front body member 122, provided that the padding has a suitable degree of softness. Stitches made with a needle and thread, for example, compress the soft padding with the outer surface of the front body member 122 to form such sectional elements 122b.

In FIG. 1a, there is depicted a fragmentary view of FIG. 1, enlarged enough to show clearly the first belt holder 126 attached to the front body member 122 of the body component 120 as previously described in FIG. 1. The body component 120 preferably includes two first belt holders 126. The two first belt holders 126 are fixedly secured on the portions of the front body member 122 closest to the shoulders of a passenger wearing the supplemental restraint system 100. There are many ways to configure the first belt holders 126 in order for the same to become suitable for receiving and holding in place a shoulder belt section of a conventional vehicle seat belt. In one embodiment, the two first belt holders 126 are in the form of side-release fastening arrangement of the kind similar to the fastening arrangements exemplified above. Although the side-release fastening arrangement is deemed sufficient to hold in place a shoulder belt section of a conventional vehicle seat belt, another layer of protection may also be employed. In one embodiment, the additional layer of protection is in the form of velcro arrangement. When attached together, the velcro arrangement substantially makes the side-release fastening arrangement not accessible. With such an additional layer of protection, the shoulder belt section of a conventional seat belt is not just held tighter in place but the side-release fastening arrangement is nonetheless protected from accidental, unintentional release. It has also been observed that side-release fastening arrangements are often a subject of a child's attention, and there is hence the tendency of the child to play on the side-release fastening arrangements as they more or less look like plastic toys. Accidental release of the side-release fastening arrangements may compromise the safety of the child wearing the supplemental restraint system 100. Differently put, and in use, the velcro arrangement hides each of the first belt holders 126. This in effect makes the side-release fastening arrangements unnoticeable to a child wearing the supplemental restraint system 100, and the possible inclination of the child to play on the side-release fastening arrangements is substantially reduced, if not completely eliminated.

In FIG. 1b, there is shown another fragmentary view of FIG. 1, enlarged to show an alternative embodiment for a first belt holder 126 of the supplemental restraint system 100 as shown in FIG. 1. In this preferred embodiment, the first belt holder 126 includes a shoulder belt positioner 126e which serve as a guide for keeping a shoulder belt section (SB) of a conventional seat belt in a stable position. Once said shoulder belt section (SB) is held in a stable position by the positioner 126e, the female buckle member 126a and the male buckle member 126b can be properly assembled together. In this manner, the assembly of the female buckle member 126a and the male buckle member 126b can be done without the shoulder belt section (SB) interfering with any of them. This provides a user with the convenience of assembling together the female and male buckle members 126a, 126b using two hands, as none of the two hands is constrained in applying pressure on the shoulder belt section (SB) against the surface of the front body member 122, whereby the shoulder belt section (SB) is prevented from interfering with the assembly of the female and male buckle members 126a, 126b. In effect, the positioner 126e restrains the movement of the shoulder belt section (SB) positioned within the first belt holder 126.

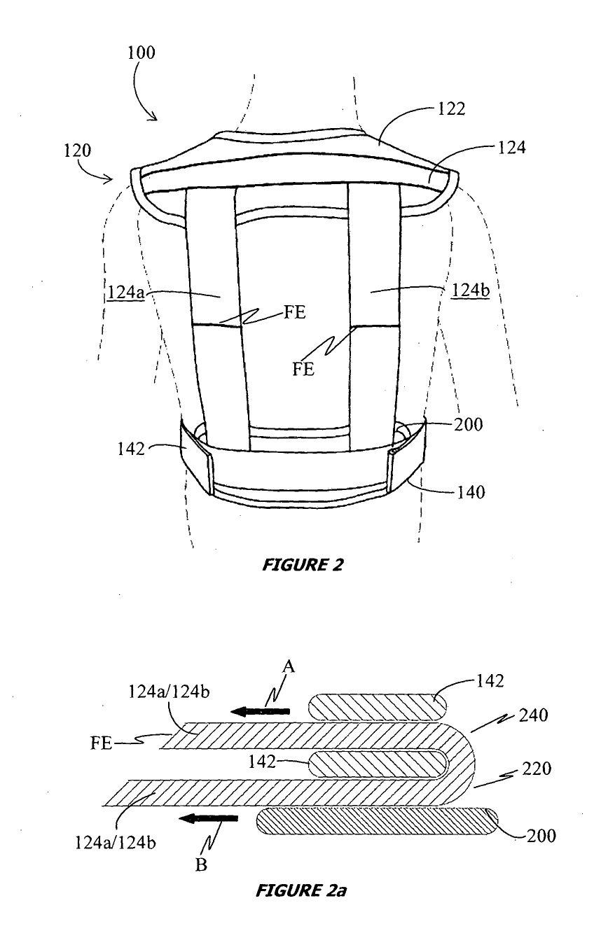

Referring now to FIG. 2, there is shown in great detail the back body member 124 of the supplemental restraint system 100 as illustrated in FIG. 1. The back body member 124 is a part of the supplemental restraint system 100 that extends from the front body member 122. In a preferred embodiment, the front and back body members 122, 124 are integrally formed, providing a unitary length of the body component 120. Although the unitary length of body component 120 is possible to be arranged during manufacturing with efficiency, passengers may not find the same comfortable. Especially that the present invention is suitable for use by children including young toddlers whose ages are generally between three and eight years, it is important that the supplemental restraint system 100 be arranged in such a manner that it provides sufficient ventilation. For example, the unitary length of the body component 120 may be provided with a plurality of holes (not illustrated) in order to provide sufficient ventilation. Alternatively, the unitary length of the body component 100 may likewise be formed of a suitable material that is naturally comfortable. Alternatively, another preferred embodiment of the present invention, as illustrated, provides that the back body member 124 includes two lengths of support straps 124a, 124b, that have substantially narrow widths. Each of the support straps 124a, 124b has two ends, one of which is attached to the piece of material extending from the unitary length of the front and back body members 122, 124, and the other is a free end (FE) that passes through a channel formed in the first strap member 142 of the strap component 140. One end of each of the two support straps 124a, 124b is preferably sewn with the portion of the front body member 122 in order to ensure reliability of the attachment. The two support straps 124a, 124b can be attached to the strap component 140 parallel to one another or in a manner that they intersect each other. Preferably, the support straps 124a, 124b are made of flexible materials to fit the contour or curves of the wearer's body and have lengths that are adjustable to suit the length of the wearer's torso. The length of each of the support straps 124a, 124b is configured to be adjustable without using any hardware component such as a square ring and double sliders. The configuration by which the free end (FE) of each of the support straps 124a, 124b passes through a channel formed in the first strap member 142 of the strap component 140 acts like a square ring or double sliders, wherein said channel is better illustrated in FIG. 2a. One strap may be used instead of two straps, depending on the overall size of the supplemental restraint system 100. Three straps can also be provided, still depending on the size of the supplemental restraint system 100. It has been found out that the use of two straps, at the optimum, provides a more stable restraining force than the use of one strap, as a single strap may become unstable for bigger sizes of the supplemental restraint system 100. By virtue of using the two lengths of straps, a passenger wearing the supplemental restraint system is afforded great comfort since the passenger's back portion leaning against a vehicle seat is sufficiently ventilated. This becomes advantageous especially in cases where there is no operational air conditioning unit circulating the air inside a vehicle. In a further preferred embodiment, the point where the respective ends of the two lengths of support straps 124a, 124b and the portion of the first strap member meets together is provided with a small piece of padding 200. This padding 200 serves as a cushioning material between a passenger's back and the point where the free end (FE) of each of the lengths of the support straps 124a, 124b passes through said channel formed in the first strap member 142. The padding may be made of a material that is similar to the material of the front body component 122 or any material that may serve as a cushion so as to protect a passenger's back from any discomfort possibly arising from the portions of the support straps 124a, 124b and first strap member 142 that are assembled together.

In FIG. 2a, there is shown a cross sectional fragmentary view of FIG. 2, enlarged to show the assembly of each of the support straps 124a, 124b and first strap member 142 in such a manner that the length of each of the support straps 124a, 124b is arranged to be adjustable. Each of the support straps 124a, 124b is formed of an open loop with which the first strap member 142 is coupled such that a free end (FE) of each of the support straps 124a, 124b passes freely through a first channel 220 formed between the first strap member 142 and the padding 200 and then through a second channel 240 formed by the first strap member 142. A desirable length of each of the support straps 124a, 124b can be determined by pulling either the free end (FE) or the other end thereof. By pulling the free end (FE) of any of the support straps 124a, 124b in the direction indicated by arrow A, the entire length of the respective support strap 124a, 124b can be made shorter. By pulling the other end of any of the support straps 124a, 124b in the direction indicated by arrow B, the entire length of the respective support strap 124a, 124b can be made longer. The free end (FE) of each of the support straps 124a, 124b and the other end of the same can be attached together using for example a typical velcro arrangement. With such configuration, the first strap member 142 functions like a square ring or double sliders. Thus, use of such hardware components and the like is no longer required in making each of the support straps 124a, 124b adjustable in length.

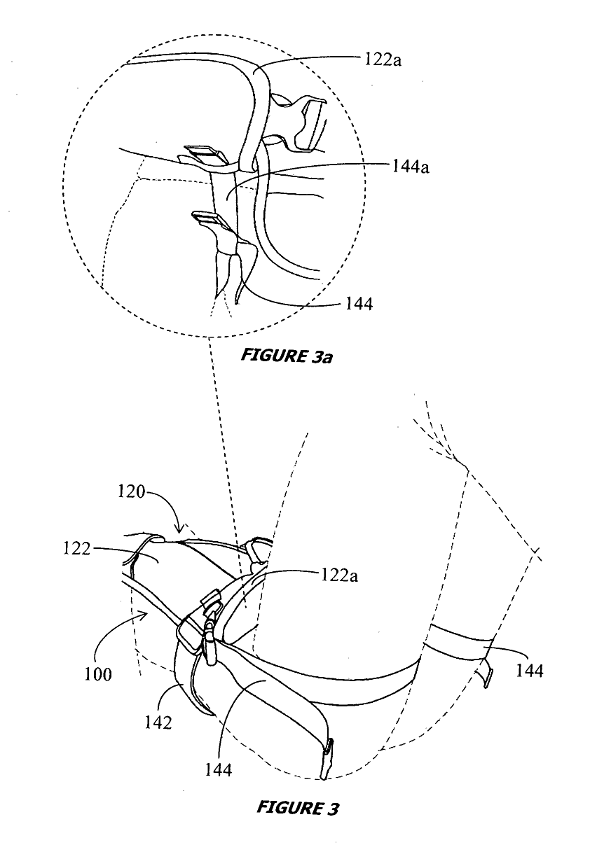

Referring to FIG. 3, there is shown another isometric view of a preferred embodiment for a supplemental restraint system clearly showing a second strap member 144. Preferably, the second strap member 144 extends from the body component 120 and more particularly from the first strap member 142 of body component 120. The second strap member 144 is of adjustable length that may be arranged to surround the lower hip portion and the upper leg portion of a wearer's body. As an alternative, the second strap member 144 may be strained by a suspender 144a that passes through the concourse of a wearer's legs. The suspender 144a is in the form of a continuous loop with detachable connection point. The suspender 144a is arranged to attach a portion of the second strap member 144 that lies along the concourse of a wearer's hips to the lower end portion of the front body member 122. In this manner, the second strap member 144 is prevented from displacement in the direction away from the wearer's hips. Preferably, the suspender includes a side-release fastening arrangement providing the detachable connection point so that, if desired, the second strap member can be removed easily away from the wearer's hips. This side-release fastening arrangement providing the detachable connection point may also be suitably replaced by a snap or plastic hook. In order for the suspender 144a to constantly pull the second strap member 144 and consequently sustain the strain that the suspender 144a applies to the second strap member 144, the suspender 144a may be suspended from the lower end portion 122a of the front body member 122. A preferred embodiment provides that the suspender 144a, which in essence connects the second strap member 144 with the lower end portion 122a of the front body member 122, includes a side-release fastening arrangement. The use of the second strap member 144 that is suspended by the suspender 144a prevents a passenger wearing the supplemental restraint system 100 from accidentally sliding out of the supplemental restraint system 100. In cases where the supplemental restraint system 100 is loosely worn by a child in particular, there is a tendency that the child may suddenly descend or slide out of the vest most especially during times that the child intends to play. The case is also the same when a child desires to reach a distant object and consequently keeps pressing in the direction of an opening formed by the body component 120 and more particularly by the first strap member 142. Yet, another preferred embodiment of the present invention provides that the second strap member 144 can be arranged to extend from the body component 120 at a front side of the first strap member 142 attached to the body component 120. The second strap member 144 can then be adapted to be positioned around an inner thigh of the passenger wearing the supplemental restraint system 100 from a posterior side to an anterior side of the thigh of the passenger. In use, the second strap member 144 of such configuration can be used in a manner that it is positioned around an inner right thigh of the passenger if a shoulder belt section of a conventional seat belt comes from a right direction and hence the shoulder belt section does not interfere with the second strap member 144 wrapped around the right thigh of the passenger. For the same reason, the second strap member 144 of the same configuration can be used in a manner that it is positioned around an inner left thigh of the passenger if the shoulder belt section comes from a left direction.

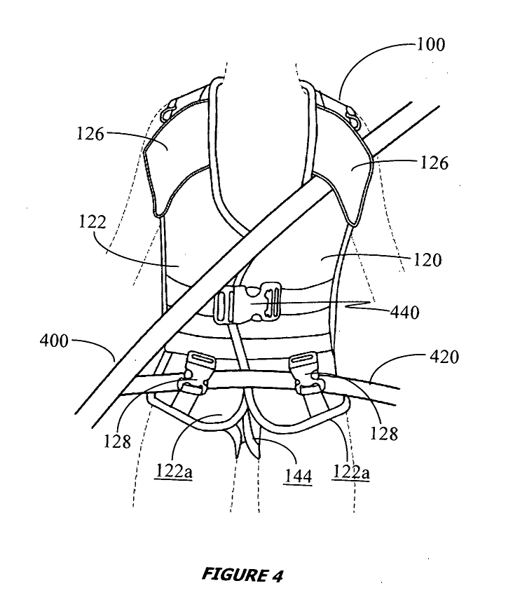

Referring to FIG. 4, there is shown a front view of an embodiment of the present invention in use. The supplemental restraint system 100 of the present invention can be used easily and is suitable for small children. While it is arguable that there are a number of side-release fastening arrangements employed in the supplemental restraint system 100 of the present invention which in turn may cause inconvenience and discomfort to the children, these side-release fastening arrangements are arranged in such a manner that they do not come in direct contact with the skin of the children. That is to say, no single portion of each of the side-release fastening arrangements comes in contact with the skin of the children wearing the supplemental restraint system 100 of the present invention. In a preferred embodiment, all of the side-release fastening arrangements are covered by padding or cushioning materials so that the side-release fastening arrangements are made inaccessible to the children wearing the supplemental restraint system 100 of the present invention. Covering these side-release fastening arrangements also minimizes the chances of the children to play on them and therefore reduces as well the chances of the children acquiring related injuries. Injuries to the hands often occur, for example, when a child attempts to disengage any of the side-release fastening arrangements and most especially when the child engages back the male and female buckle members of any of the side-release fastening arrangements. Either the fingers of the child are pinched by the engaging male and female buckle members of the side-release fastening arrangement or cut due to the presence of protrusions, depressions and uneven surfaces on the side-release fastening arrangement. These protrusions, depressions, and uneven surfaces may have sharp edges that are commonly caused by a manufacturing operation such as, for example, moulding. The padding or cushioning should be sufficient enough to cover the side-release fastening arrangements, making the female and male buckle members of the side-release fastening arrangements unnoticeable to the children wearing the supplemental restraint system 100 of the invention.

In use, the supplemental restraint system 100 of the present invention may be worn by a child before the child enters a vehicle. Wearing the supplemental restraint system 100 of the present invention is very convenient both for the person assisting the child and for the child himself. The supplemental restraint system 100 of the present invention can be mounted onto the child's body by first passing the neck and head opening through the head of the child until the shoulder portions of the body component 120 reach the child's shoulders. The supplemental restraint system 100 of the present invention can be secured about the torso of the child and can be worn by the child like an ordinary jacket that is customarily provided with front body closure means such as in the form of a side-release buckle arrangement 440. Such front body closure means is commonly disposed on or adjacent the free edges of the jacket below its neck opening. Once the supplemental restraint system 100 of the present invention is completely secured about the torso of the child, the open portion of the front body member 122 can then be connected by a side-release fastening arrangement 440. A person skilled in the art could easily realize that such as side-release fastening arrangement may be replaced suitably by known closure means such as for example a zipper, a set of buttons, hook and pile type fasteners, and snaps. The portion of the second strap member 144 lying transversely along the concourse of the child's legs is then pulled using the suspender, as illustrated in FIG. 3a, which can be suspended from a lower end portion 122a of the front body member 122. The side-release fastening arrangement serving as front body closure means is attached to the first strap member of adjustable length to properly fit the diametrical size of the child's torso. The second strap member 144 may likewise be configured to be adjustable and hence fit the diametrical size of the child's legs. All these can be done leaving the female and male buckle members of each of the side-release fastening arrangements disengaged.

Once the child has entered a vehicle and is seated inside it, the shoulder and lap belt sections 400, 420 of the vehicle seat's pre-installed seat belt can be secured onto the supplemental restraint system 100. If the child is of age that is capable of helping himself in securing the shoulder and lap belt sections 400, 420 of the seat belt, then the child can easily do so by pulling a portion of the seat belt, securing the pulled portion of the seat belt in place, ensuring that the shoulder belt section 400 passes through one of the first belt holders 126 disposed on the upper part of the front body member 122 and that the lap belt section 420 passes through the second belt holders 128 in the lower end portion 122a of the front body member 122, and finally engaging the male and female buckle members of the each of the side-release fastening arrangements which are left disengaged prior to entering of the child into the vehicle.

Once the shoulder belt section 400 and lap belt section 420 are securely held in place with the supplemental restraint system 100, the child is securely restrained from moving or accidentally falling out of the vehicle's seat. The engagement of the shoulder belt section 400 of the seat belt and one of the first belt holders 126 is such that the child is still able to conveniently turn his neck and move his head without interference from the shoulder belt section 400 which is securely held away from the head and neck of the child. In such arrangement, the child is restrained by the supplemental restraint system 100 of the present invention only from his upper torso, to his waist portion, down to his hips portion. The only time that the child is freed from restrained condition is when the shoulder and lap belt sections 400, 420 are disengaged from the supplemental restraint system 100 of the present invention. Although an embodiment of the present invention provides a provision for both of the shoulder belt and lap belt sections 400, 420 to be secured in the supplemental restraint system 100 of the present invention, it must be understood that the supplemental restraint system 100 can also be used with a lap belt alone. There are vehicle seats that are not equipped with seat belts having both shoulder and lap sections. The back seats of most cars alone are not provided with seat belts that have shoulder belt sections. Lap belts are commonly used in back seats and in other types of vehicles such as buses and airplanes and in amusement rides such as roller coasters and bumper cars. This means that the use of the supplemental restraint system 100 of the present invention is not limited to the vehicles of the type employing the conventional seat belt having both shoulder and lap belt sections.

In releasing the supplemental restraint system 100 from the body of the child, all that is required is to disengage the female and male buckle members of the side-release fastening arrangement that is attached to the body component 120 of the supplemental restraint system 100, disengage the female and male buckle members of the side-release fastening arrangement that is attached to the lower end portion 122a of the front body member 122, disengage the second strap member 144 from the first strap member 142 and finally to pull the body component 120 off the body of the child as if the child is simply undressed with a regular jacket. Needless to say, the supplemental restraint system 100 of the present invention as embodied herein can be used with great convenience especially during emergency cases where pulling the supplemental restraint system 100 off the body of the child is urgently required.

Furthermore, the configuration of the supplemental restraint system 100 is such that easy storage and portability are readily provided. The body component 120 and strap component 140 of the supplemental restraint system 100 are made from substantially soft and lightweight material that can be folded into a compact unit for easy storage and transportation. The supplemental restraint system 100, when folded into a compact unit, can be stored for example in a small bag or child's knapsack in a convenient manner. Another notable advantage of the supplemental restraint system 100 of the present invention is that any of its components does not include a metallic material. Use of metallic materials poses some serious risk in the life of a passenger.

The above-described embodiments are not intended to limit the scope of the present invention. The materials, sizes, and shapes are only described so as to demonstrate preferred embodiments of the present invention.

1. A supplemental restraint system for use in restraining an individual in a seat of a vehicle equipped with a safety harness having a shoulder belt section and a lap belt section, the supplemental restraint system comprising:
a body component having a front body member and a back body member defining a neck opening for receiving a wearer's neck and head, the front body member having one end portion that extends to a wearer's lap, the body component further having at least one first belt holder disposed on the front body member thereof for receiving a shoulder belt section of a safety harness, the body component further having at least one second belt holder disposed on the end portion of the front body member thereof for receiving a lap belt section of a safety harness; and
a strap component having at least a first strap member and a second strap member, the first strap member being disposed on the body component for receiving a wearer's body, the second strap member extending from the body component for receiving a wearer's hips.

2. The supplemental restraint system according to claim 1, wherein the back body member includes at least one support strap.

3. The supplemental restraint system according to claim 2, wherein the support strap has a length being configured to be adjustable without using any hardware component.

4. The supplemental restraint system according to claim 1, wherein the first strap member has a length being configured to be adjustable, and wherein the first strap member includes at least two separate portions which enable bilateral adjustment.

5. The supplemental restraint system according to claim 1, wherein the second strap member has an adjustable length.

6. The supplemental restraint system according to claim 1, wherein the end portion of the front body member is adapted to fold when a wearer of the supplemental restraint system is in a seated position.

7. The supplemental restraint system according to claim 6, wherein the end portion of the body component and the front body member are one-piece.

8. The supplemental restraint system according to claim 1, wherein each of the first and second belt holders includes a side-release fastening arrangement comprising female and male buckle members.

9. The supplemental restraint system according to claim 8, wherein the female and male buckle members are made from plastic materials.

10. The supplemental restraint system according to claim 1, wherein the body component further includes a shoulder belt positioner being configured to restrain the movement of a shoulder belt section for positioning within the first belt holder.
